(19) United States
(12) Patent Application Publication
(10) Pub. No.: US 2017/0247190 A1
(43) Pub. Date: Aug. 31, 2017

(54) Article Transport Facility

(71) Applicant: Daifuku Co., Ltd., Osaka-shi (JP)

(72) Inventors: Takahiro Horii, Kusatsu-shi (JP); Yoshinari Wada, Omihachiman-shi (JP)

(21) Appl. No.: 15/442,949

(22) Filed: Feb. 27, 2017

(30) Foreign Application Priority Data
Feb. 29, 2016 (JP) 2016-037786

(51) Int. Cl. B65G 19/02; B66C 1/00

(52) U.S. Cl. CPC B65G 19/025; B66C 1/00

(57) ABSTRACT

An article transport facility includes an article transport vehicle which is suspended from and supported by one or more travel rails supported by a ceiling, and is configured to suspend and support an article, and to transport the article from a support platform that serves as a transport origin to another support platform that serves as a transport destination. This article transport facility has an adjusting-purpose support platform which includes an adjusting-purpose support surface on which an adjusting-purpose device, which is used for a purpose of adjusting transporting-purpose profile information, can be placed in the same manner in which an article is placed on a support platform. The adjusting-purpose support surface is capable of being moved such that a height thereof can be varied continuously between an upper limit height and a lower limit height specified in advance.

### CROSS-REFERENCE TO RELATED APPLICATION

This application claims priority to Japanese Patent Application No. 2016-037786 filed Feb. 29, 2016, the disclosure of which is hereby incorporated in its entirety by reference.

### FIELD OF THE INVENTION

The present invention relates to an article transport facility includes an article transport vehicle which is configured to travel while being suspended from and supported by one or more travel rails supported by a ceiling, and is configured to suspend and support an article, and to transport the article from a support platform that serves as a transport origin to another support platform that serves as a transport destination.

### BACKGROUND ART

The article transport faculties have been in use in which articles are automatically transported by means of article transport vehicles suspended from rails provided to the ceiling. In order to transfer an article with high accuracy, or more specifically, in order to accurately hold an article at the location the article is picked up (transport origin), and to transport, unload and place the article accurately in a preset position at a transport destination, it is preferable that the stop position of the article transport vehicle and the position at which the support portion holds and supports the article are adjusted accurately. A technology for performing such adjustments (i.e., teaching) is disclosed in, for example, JP Publication of Application No. 2009-35403 (see Paragraphs [0049]-[0064], FIG. 1-FIG. 3, for example). In this reference, the adjusting involves the article transport vehicle performing transporting operation using a support platform on which an article is actually placed. When the adjusting is done using a support platform on which an article is actually placed, the support platform cannot be used while the adjusting is being done, which may reduce the operational efficiency of the article transport facility.

To address this problem, it is conceivable to perform the adjustment by providing a separate support platform for adjusting purpose (adjusting-purpose support platform for short) that is configured to support an article at a position located at the height of the actual support platform (i.e., the height from the ground, or the distance from the rails on the ceiling side to the support surface of the support platform). See, for example FIG. 14 of the present application. This adjusting-purpose support platform 400 is configured to support a unit C for adjusting purpose (which will be referred to as an adjusting-purpose unit for short and which is used in place of an article and is placed in the adjusting-purpose support platform 400) on support surfaces P (P101-P103) for adjusting purpose (adjusting-purpose support surfaces for short) located at different heights. The adjusting-purpose support platform 400 has vertical frame members BG and support portions SS that span between the vertical frame members BG in this example. Each support portion SS is configured to be pivoted by an actuator (not shown) such that its attitude can be switched or changed between a state in which the adjusting-purpose support surface P extends along the vertical (up and down) direction and a state in which the adjusting-purpose support surface P extends horizontally. However, such a structure makes it difficult to flexibly set the height of the adjusting-purpose support surface P to correspond to the height of the actual support platform. In addition, when the differences in the heights of different adjusting-purpose support surfaces P are small, any two support portions SSs that are adjacent each other along the vertical direction may interfere with each other so that the structure also makes it difficult to provide adjusting-purpose support surfaces P with small distances between them.

### SUMMARY OF THE INVENTION

In light of the background discussed above, a technology is desired that that can be used to more flexibly position an adjusting-purpose support surface and to adjust an article transport vehicle efficiently.

In one embodiment, an article transport facility invented in light of the above comprises:

one or more travel rails supported by a ceiling;

a plurality of support platforms provided on a ground side and along the one or more travel rails;

an article transport vehicle which is suspended from and supported by the one or more travel rails, and is configured to travel along a travel path defined by the one or more travel rails, to suspend and support an article, and to transport the article from one of the plurality of support platforms that serves as a transport origin to another of the plurality of support platforms that serves as a transport destination, wherein the ceiling transport vehicle has a travel portion configured to travel along the travel path, a support member which is supported by the travel portion and which is configured to hold, suspend, and support, the article, a vertically moving portion configured to vertically move the support member with respect to the travel portion when the travel portion is at rest, and a profile storage configured to store transporting-purpose profile information which includes at least information on an amount of operation of the support portion and the vertically moving portion for transferring an article to or from each of the plurality of support platforms;

an adjusting-purpose device which is used for a purpose of adjusting the transporting-purpose profile information;

an adjusting-purpose support platform which includes an adjusting-purpose support surface on which the adjusting-purpose device can be placed in a same manner in which an article is placed on a support platform,

wherein the adjusting-purpose device is:
(a) capable of being suspended from and supported by the support member in a same manner in which an article is suspended from and supported by the support member;
(b) capable of being placed on a support platform by the article transport vehicle in a same manner in which an article is placed on the support platform; and
(c) configured to obtain information on an amount of operation of the support portion and the vertically moving portion when an article is transferred to or from the adjusting-purpose support surface to adjust the transporting-purpose profile information, and

wherein the adjusting-purpose support surface is capable of being moved such that a height thereof can be varied continuously between an upper limit height and a lower limit height specified in advance.

Because the adjusting-purpose support platform is arranged such that the height of the adjusting-purpose support surface can be adjusted continuously, the height of the adjusting-purpose support surface can be set flexibly. For example, if the height of the adjusting-purpose support surface is fixed structurally, it is not easy to change the height of the adjusting-purpose support surface depending on the specification (for example, distance between the floor surface and the ceiling surface, etc.) of an article transport facility. Even if the structure is such that the adjusting-purpose support surface can be set at a number of discrete levels or heights, there may not be a proper level that matches a required height of the adjusting-purpose support surface. With the arrangement described above, the transporting-purpose profile information can be adjusted by making use of an adjusting-purpose support surface that is capable of being moved such that its height can be adjusted continuously. Therefore, the profile information used as a reference can be shared so that the amount of calculations required for adjusting the profile information can also be reduced. When the article transport facility has many article transport vehicles, the total amount of time required to make the adjustments can also be reduced so that the operational efficiency of the article transport facility can also be improved. Thus, the arrangement described above can provide a technology that can be used to more flexibly position an adjusting-purpose support surface and to adjust an article transport vehicle efficiently.

Additional features and advantages of the article transport facility will become clear from the following descriptions of the embodiments described with reference to the attached drawings.

### BRIEF DESCRIPTION OF THE DRAWINGS

FIG. 1 schematically shows an arrangement of an article transport facility,

FIG. 2 is an enlarged view of a branching portion,

FIG. 3 is a side view of a ceiling transport vehicle,

FIG. 4 is a block diagram schematically showing the systems of the article transport facility and a ceiling transport vehicle,

FIG. 5 is a side view showing a ceiling transport vehicle and a support platform,

FIG. 6 is a side view showing the ceiling transport vehicle and the support platform

FIG. 7 is a side view showing an example of an adjusting-purpose support platform,

FIG. 8 is a side view showing a relationship between an adjusting-purpose unit in the adjusting-purpose support platform and a ceiling transport vehicle,

FIG. 9 is a side view showing a relationship between the adjusting-purpose unit and the adjusting-purpose support platform,

FIG. 10 is an enlarged view showing the positional relationship between a adjusting-purpose support surface and the adjusting-purpose unit when the adjustment is performed,

FIG. 11 is a side view showing another example of an adjusting-purpose support platform,

FIG. 12 shows an example of a maintenance lifter,

FIG. 13 shows an example in which the adjusting-purpose support platform is combined with the maintenance lifter, and

FIG. 14 is a side view showing an example of an adjusting-purpose support platform having fixed discrete levels of support surfaces.

### DETAILED DESCRIPTION OF EMBODIMENTS

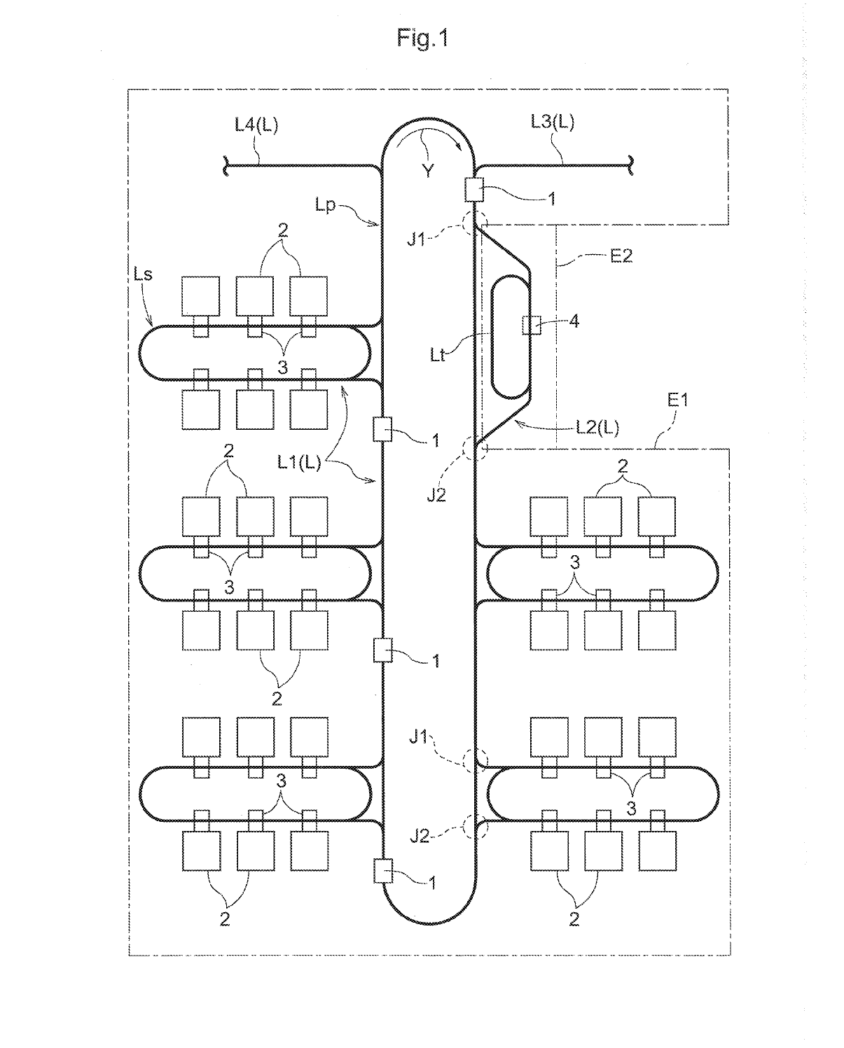

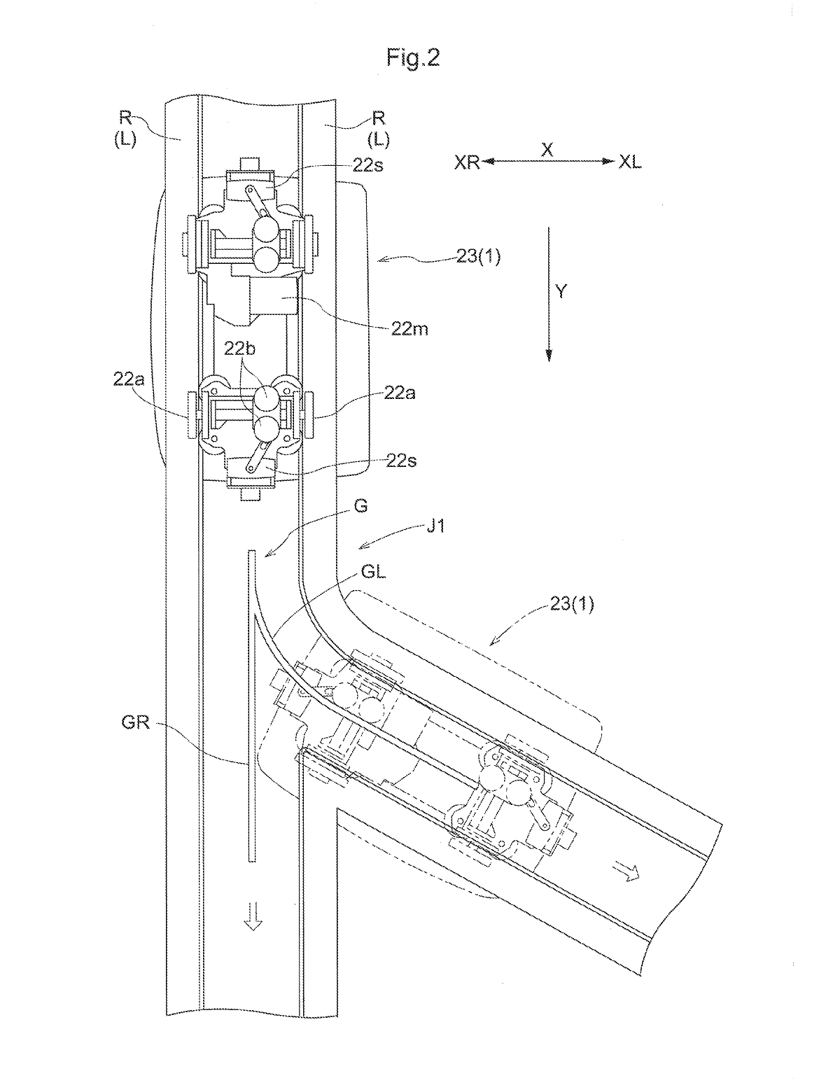

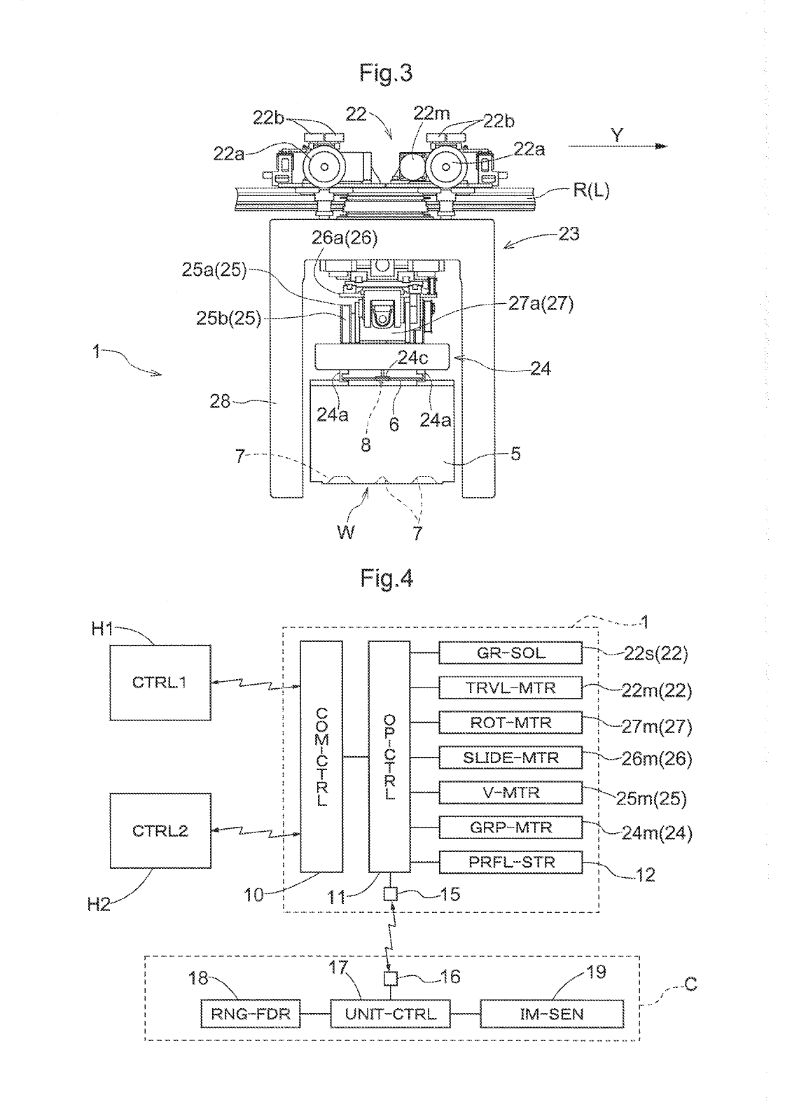

Embodiments of an article transport facility are described next with reference to the drawings. FIG. 1 schematically shows an example of an arrangement of an article transport facility. In the present embodiment, descriptions are given using an example in which the article transport facility includes article transport vehicles (ceiling or overhead transport vehicles 1) each of which travels in one direction along travel paths L to transport articles W, one at a time, between a plurality of semiconductor processing devices (processing devices 2) each of which performs one or more of various processes such as thin film formation or deposition, photo lithography, and etching, on semiconductor substrates. Each travel path L is formed or defined by travel rails R (see FIGS. 2 and 3) which are supported by support brackets and are installed on the ceiling side. The travel paths L includes branching portions J1 at each of which a path branches, or splits, off from a path and merging portions J2 at each of which a path joins, or merges into, another path. FIG. 2 shows an enlarged view of a branching portion J1 at which a travel path L branches off from a travel path L. In the present embodiment, as shown in FIG. 3, each article transport vehicle is a ceiling or overhead transport vehicle 1 which is suspended from, and supported by, the travel rails R. In the description below, the direction in which a ceiling transport vehicle 1 travels will be referred to as its travel direction Y whereas a direction that is perpendicular to the travel direction Y in plan view (i.e., direction in the horizontal plane that is perpendicular to the travel direction Y) will be referred to as a lateral direction X.

In the present embodiment, each article W is called a FOUP (Front Opening Unified Pod) as will be described below with reference to FIG. 3 and is a container for holding a plurality of semiconductor substrates. Each article W has a flange portion 6 and a holding portion 5. And a substrate entrance opening (not shown) for taking out and inserting semiconductor substrates is formed in the front face (for example, on the travel direction Y side) of the holding portion 5. This substrate entrance opening can be closed by a lid (not shown) which can be detached from, and attached to, the holding portion 5. Each processing device 2 performs one or more of various processes listed above on the substrates (semiconductor substrates) that had been held in a container (article W). In order to allow the containers (articles W) to be transported between processing devices 2, each processing device 2 has a support platform 3 (support platform) installed therefor on the floor surface (to the ground side) and near the processing device 2. These support platforms 3 are the transport target locations (each of which can be a transport origin and/or a transport destination) for the articles W that are transported by the ceiling transport vehicles 1.

Therefore, the article transport facility includes travel rails R installed to (i.e., supported by) the ceiling, a plurality of support platforms 3 provided on the ground side and along or adjacent the travel rails R (travel paths L), and ceiling or overhead transport vehicles 1. Here, the expression “provided on the ground side” means that what is provided (i.e., the support platforms 3 in the present example) are supported directly or indirectly by the ground (which is the floor in the present embodiment) as opposed to the ceiling. In addition, “provided . . . along (object(s))” means that what is provided (i.e., the support platforms 3 in the present example) are provided at locations that are close enough to the object(s) (i.e., the travel rails R in the present example) for a ceiling transport vehicle 1 to be able to transfer an article to and from the object(s) (the support platforms 3 in the present example). Each ceiling transport vehicle 1 is suspended from and supported by the travel rails R, to travel along the travel paths L defined by the travel rails R, and to transport an article W from a support platform 3 that serves as a transport origin to a support platform 3 that serves as a transport destination.

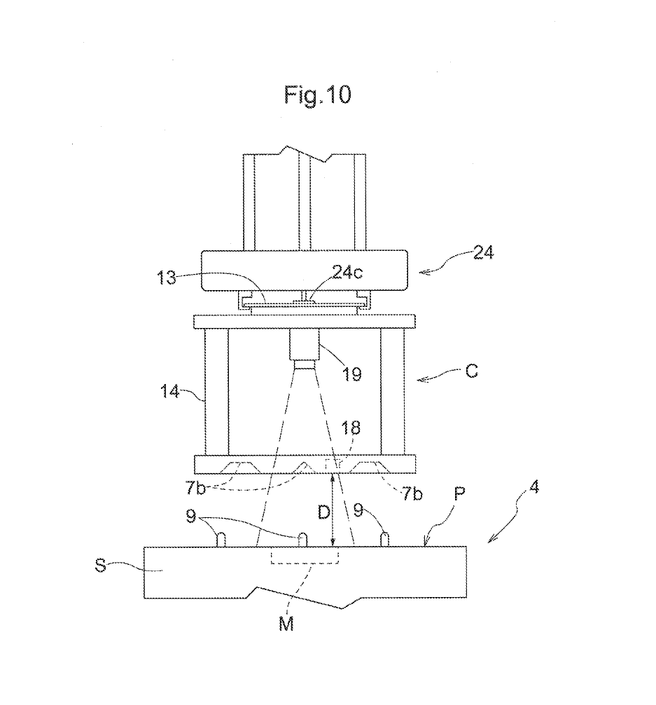

As shown in FIG. 1, at least two different areas (a first area E1 and a second area E2) that have different attributes are provided in the article transport facility. The travel paths L include first paths L1 provided in the first area E1, and second paths L2 which are provided in the second area E2 and one of which branch or split off from a first path L1 and another of which merges into or joins the first path L1. The first area E1 is an area in which the processing devices 2 described above are located and in which articles W are transported by the ceiling transport vehicles 1 between processing devices 2 (support platforms 3). The second area E2 is an area which is provided separately from the first area E1, and in which adjustments of the ceiling transport vehicles 1 are performed using an adjusting-purpose unit C described below. In the second area E2, an adjusting-purpose support platform 4 that serves as an inspection target location at which a detected member M (see FIG. 10) described below is provided is installed on the floor surface. Note that the adjusting-purpose support platform 4 and the adjusting-purpose unit C are configured such that the adjusting-purpose unit C can be placed on the adjusting-purpose support platform 4 in the same manner in which an article W is placed on a support platform 3.

The first paths L1 include a relatively large loop-shaped primary path Lp shown in the central portion in FIG. 1, and relatively small loop-shaped secondary paths Ls shown to be located on the outside of the primary path Lp. In a branching portion J1 which is a portion that branches off from the primary path Lp to a secondary path Ls, guide rails G are provided as shown in FIG. 2. A branching portion J1 also exists in a portion that branches off from the first path L1 to a second path L2. And guide rails G are similarly provided there as well. In addition, while not shown or described in detail, similar guide rails G are provided in each merging portion J2 which is a portion in which a path extending from a secondary path Ls merges into the primary path Lp. The same is true with other branching portions and merging portions (for example, the branching portion and the merging portion between the external connection paths (the inbound path L3 and the outbound path L4 which are connected to the primary path Lp) and the primary path Lp shown in an upper portion of FIG. 1).

FIG. 3 shows a side view (a view as seen along a direction perpendicular to the travel direction Y) of a ceiling transport vehicle 1. The ceiling transport vehicle 1 has a travel portion 22 which is configured to travel along the travel paths L, and a main body portion 23 which is suspended from and supported by the travel portion 22 so as to be located below the travel rails R and which has a support member 24 which is configured to support an article W. The travel portion 22 has travel wheels 22a which roll on the travel rails R installed along each travel path L, and a drive motor 22m (TRVL-MTR) for rotating the travel wheels 22a.

As shown in FIGS. 2 and 3, the travel portion 22 is also provided with guide rollers 22b which are guided by the guide rails G provided in branching portions J1 and merging portions J2 of the travel paths L. The guide rollers 22b are so configured that their attitude or position can be changed along a right and left direction (lateral direction X) as seen in the direction along the travel direction Y of the travel portion 22. Attitude or position change of the guide rollers 22b is performed by solenoids (guide roller solenoids GR-SOL) 22s (see FIGS. 2 and 4). Each guide roller solenoid 22s changes the position of the guide rollers 22b to a first position which is a right-hand side (right XR side) position and to a second position which is a left-hand side (left XL side) position, as seen in the travel direction Y, and holds the guide rollers 22b in that position. When in the first position, the guide rollers 22b come into contact with the right-hand side surface of the guide rail G as seen in the direction along the travel direction Y, and guide the travel portion 22 along the guide rail GR that does not branch off (or the guide rail (guide rail GR that extends straight forward) that extends on the right-hand side relative to the other guide rail as seen in the travel direction Y). When in the second position, the guide rollers 22b come into contact with the left-hand side surface of the guide rail G as seen in the direction along the travel direction Y, and guide the travel portion 22 along the guide rail GL that extends to the left-hand side (i.e. along the branching side guide rail GL).

As shown in FIG. 3, the flange portion 6 of the article W is provided in the upper end portion of the article W (i.e., at a higher position than the holding portion 5), and is configured to be supported by the support member 24 of the ceiling transport vehicle 1. The ceiling transport vehicle 1 transports an article W with the flange portion 6 suspended from, and supported by, the support member 24. As shown in FIG. 3, three bottom surface recesses 7 each of which is a groove that is recessed upward are provided or formed in the bottom surface of the holding portion 5 (i.e., the bottom surface of the article W). Each of the three bottom surface recesses 7 is formed such that it tapers toward its top portion so that each inward surface of each bottom surface recess 7 is a sloped surface. The function of these bottom surface recesses 7 is described below. In addition, as shown in FIG. 3, a top surface recess 8 that is generally formed in a conical shape that is recessed downward is formed in the top surface of the flange portion 6 (i.e., the top surface of the article W). The top surface recess 8 is formed such that it tapers toward its top end so that the inward surface of the top surface recess 8 is a sloped surface. The function of the top surface recess 8 is also described below.

The main body portion 23 of the ceiling transport vehicle 1 has the support member 24, a vertically moving portion 25, a slide portion 26, a rotation portion 27, and a cover member 28. The support member 24 is a mechanism configured to suspend and support an article W. The vertically moving portion 25 is an actuator configured to vertically move the support member 24 with respect to the travel portion 22. The slide portion 26 is an actuator configured to slide the support member 24 along the lateral direction X with respect to the travel portion 22. The rotation portion 27 is an actuator configured to rotate the support member 24 about a vertical axis (i.e., axis not shown but extending along the vertical direction) with respect to the travel portion 22. As shown in FIG. 3, the cover member 28 is a member that covers an area above, and areas forward and backward of, an article W when the support member 24 supporting the article W is in a set raised position described below. The set raised position is a position specified in advance as a position along the up and down direction (vertical direction) at which the support member 24 is located when the ceiling transport vehicle 1 travels along the travel rails R while supporting an article W.

The block diagram of FIG. 4 schematically shows the systems of the article transport facility and a ceiling transport vehicle. A first controller (CTRL1) H1 is a system controller which serves as a core component of the article transport facility. The first controller H1 is a controller that is superordinate to the ceiling transport vehicles 1, controls operations of the ceiling transport vehicles 1 mainly in the first area E1, and is a controller that serves as a core of transport control for transporting articles W. A second controller (CTRL2) H2 is a superordinate controller that serves as a core of adjustment control for adjusting the ceiling transport vehicles 1, and is a controller that controls the operations of the ceiling transport vehicles 1 in the second area E2. Although a separate controller that serves as the core for the control of the ceiling transport vehicles 1 is installed for each of the first area E1 and the second area E2 in the present embodiment, this does not preclude, and is possible to have, an arrangement in which the ceiling transport vehicles 1 are controlled in both areas (E1, E2) by a single common controller.

As shown in FIG. 4, each ceiling transport vehicle 1 has a communication controller (COM-CTRL) 10, an operation controller (OP-CTRL) 11, a profile storage or memory (PRFL-STR) 12, and a communication portion 15 for adjusting purpose (adjusting-purpose communication portion for short). The communication controller 10 has, for example, an antenna and a communication-control circuit, etc., that are compatible with wireless LAN etc., and performs wireless communication at least with the first controller H1 and the second controller H2. The operation controller 11 consists of, among other components, a microcomputer, and operates the ceiling transport vehicle 1 under an autonomous control based on commands from the first controller H1 and the second controller H2.

The profile storage 12 consists of a storage media, such as a memory circuit, and stores profile information for transporting purpose (transporting-purpose profile information for short) which includes the position for transferring the article W at each support platform 3 (to or from each support platform 3) and information on the amount of operation or movements. The position information includes “transporting-purpose stop target position information” and “transporting-purpose transfer reference operation amount information” for transporting an article W to, and transferring the article W at, each support platform 3. As will be described in greater detail below, the transporting-purpose stop target position information is information that indicates the target position (transporting-purpose stop target position) at which the travel portion 22 is caused to stop on the travel rails R (i.e., in a travel path L especially in a first path L1). In addition, the transporting-purpose transfer reference operation amount information is information that indicates the amounts of operations (“transporting-purpose transfer reference operation amounts” of a vertical movement, rotation, sliding movement, which will be described in detail below) by which the support member 24 is moved with respect to the travel portion 22, while the travel portion 22 is at rest on the travel rails R (i.e., in a travel path L especially in a first path L).

The adjusting-purpose communication portion 15 consists of, for example, an antenna and a communication-control circuit that are compatible with a short-range wireless communications standard. While a more detailed description will be provided below, the adjusting-purpose communication portion 15 performs wireless communication with a unit communication portion 16 of the adjusting-purpose unit C, and receives updated transporting-purpose profile information or profile information for updating (for example, information indicating the difference between old and updated transporting-purpose profile information) is received.

The support member 24 which is a part of the main body portion 23 is provided with a pair of gripping claws 24a (see FIG. 3), and a motor 24m for moving the claws 24a (or gripper motor for short, see GRP-MTR in FIG. 4). As shown in FIG. 3, each gripping claw 24a in the pair is generally formed in the shape of an L as seen from a side (i.e., as seen along the X-direction) so that the flange portion 6 can be supported from below by the lower end portion of each gripping claw 24a. The pair of gripping claws 24a are moved horizontally toward and closer to, and away from, each other by the actuating force of the gripper motor 24m. The support member 24 is configured to be switched or changed to a support state and a support release state, and to be placed in the support state as the result of the pair of gripping claws 24a moved closer to each other and in the support release state as the result of the pair of gripping claws 24a moved away, and farther apart, from each other.

As shown in FIG. 3, the support member 24 configured to suspend and support an article W is supported by the travel portion 22 for vertical movement with respect to the travel portion 22, by means of a vertically moving portion 25 which is also a part of the main body portion 23 as with the support member 24. The vertically moving portion 25 has winding members 25a, spool belts 25b, and a motor 25m for vertically moving the support member 24 (or a vertical movement motor for short, see V-MTR in FIG. 4). Each spool belt 25b is an example of a flexible elongate member. The winding members 25a are supported by a rotatable member 27a described below. Each spool belt 25b is spooled onto a winding member 25a, and its distal end portion is connected to the support member 24 so that the support member 24 is supported by means of the spool belts 25b. The vertical movement motor 25m provides the power for rotating the winding members 25a. Each spool belt 25b is spooled onto its winding member 25a as the winding member 25a is rotated in a forward direction by the vertical movement motor 25m whereas each spool belt 25b is fed out from its winding member 25a as the winding member 25a is rotated in a backward or reverse direction by the vertical movement motor 25m. This is how the support member 24 and the article W supported by support member 24 are moved vertically. Note that the vertically moving portion 25 is provided with an encoder (not shown) for measuring the amount of a spool belt 25b fed out by a winding member 25a by counting the number of pulses. The operation controller 11 controls the vertical movement height of the support member 24 based on this number of pulses.

A slide portion 26 which similarly is a part of the main body portion 23 has a relay portion 26a (see FIG. 3), and a motor 26m for causing sliding movement (or sliding movement motor for short, see SLIDE-MTR in FIG. 4). The relay portion 26a is supported by the travel portion 22 such that it can slide along the lateral direction X with respect to the travel portion 22. The sliding movement motor 26m provides the power for causing the relay portion 26a to slide along the lateral direction X. The slide portion 26 moves the support member 24 and the vertically moving portion 25 along the lateral direction X by causing the relay portion 26a to slide along the lateral direction X by the actuating action of the sliding movement motor 26m.

The rotation portion 27 which similarly is a part of the main body portion 23 has a rotatable member 27a (see FIG. 3), and a motor 27m for causing rotation (or a rotating motor for short, see ROT-MTR in FIG. 4). The rotatable member 27a is supported by the relay portion 26a such that the rotatable member 27a can be rotated about a vertical axis extending along the vertical direction (or up and down direction). The rotating motor 27m provides the power for rotating the rotatable member 27a about the vertical axis. The rotation portion 27 causes the support member 24 and the vertically moving portion 25 to be rotated about the vertical axis by rotating the rotatable member 27a by the actuating action of the rotating motor 27m.

For example, transporting-purpose transfer reference operation amount is given in terms of a rotation operation amount which specifies the amount of rotation of the support member 24 about the vertical axis with respect to the travel portion 22, a sliding operation amount which specifies the amount of movement of the support member 24 along the lateral direction X with respect to the travel portion 22, a lowering operation amount which specifies the amount of operation or movement of the support member 24 along the vertical direction with respect to the travel portion 22. In this case, it is preferable that the position of the support member 24 about the vertical axis when the travel portion 22 is traveling on the travel rails R is defined to be the reference position for rotation (or rotation reference position for short), that the position of the support member 24 along the lateral direction X when the travel portion 22 is traveling is defined to be the reference position for sliding movement (or sliding movement reference position for short), and that the position of the support member 24 along the vertical direction when the travel portion 22 is traveling is defined to be the set raised position. That is, a travel purpose position of the support member 24 (i.e. the position of the support member 24 for the purpose of traveling) is such a position that the support member 24 is located at the rotation reference position about the vertical axis, is located at the sliding movement reference position along the lateral direction X, and is located at the set raised position along the vertical direction. Each ceiling transport vehicle 1 travels along travel rails R with the support member 24 in its travel purpose position.

Incidentally, as described above with reference to FIG. 1, at least two different areas (a first area E 1 and a second area E2) that have different attributes (i.e., each having an attribute that is different from that of the other) are provided in the article transport facility. Each ceiling or overhead transport vehicle 1 transports an article W between a plurality of support platforms 3 in the first area E1. The second area E2 is an area in which adjustments of the ceiling transport vehicles 1 are performed, and in which an adjusting-purpose support platform 4 which serves as an inspection target location is installed on the floor surface. In addition to the transporting-purpose stop target position information and the transporting-purpose transfer reference operation amount information for transporting an article W to, and transferring the article W at, each support platform 3, the profile information stored in the profile storage 12 also includes stop target position information for adjusting purpose (or “adjusting-purpose stop target position information” for short) and transfer reference operation amount information for adjusting purpose (or “adjusting-purpose transfer reference operation amount information” for short).

The adjusting-purpose stop target position information is information that indicates the target position (stop target position for adjusting purpose or adjusting-purpose stop target position for short) at which the travel portion 22 is caused to stop on the travel rails R (i.e., in a travel path L especially in a second path L2). In addition, adjusting-purpose transfer reference operation amount information is information that indicates the amounts of operations (“adjusting-purpose transfer reference operation amounts”) for effecting various movements (vertical movement, rotation, sliding movement) by which the support member 24 is moved with respect to the travel portion 22, while the travel portion 22 is at rest on the travel rails R (i.e., in a travel path L especially in a second path L2).

The operation controller 11 performs transport control and adjustment control based on transport commands from the first controller H1 and the second controller H2 which are superordinate to the operation controller 11. The operation controller 11 controls operations of the various actuators provided to the ceiling transport vehicle 1 when performing the transport control and the adjustment control. The transport control is described first. The transport control is a control for transporting an article W from a support platform 3 from which the article is picked up (support platform 3 of transport origin) to a support platform 3 that is the destination of the transport operation (or a support platform 3 of transport destination) by receiving the article W from the support platform 3 of transport origin and delivering or transferring the article W to the support platform 3 of transport destination. In response to a transport command for transporting an article W from the support platform 3 of transport origin to the support platform 3 of transport destination, specific operations, namely, a receiving travel operation, a receiving vertical movement operation, a delivering travel operation, and a delivering vertical movement operation, are performed in that order.

In the receiving travel operation, the operation controller 11 controls the drive motor 22m based on transporting-purpose stop target position information about the support platform 3 specified as the transport origin, to cause the travel portion 22 to travel to the transporting-purpose stop target position for the support platform 3 of transport origin, and to cause the travel portion 22 to stop at the transporting-purpose stop target position.

In the receiving vertical movement operation, the operation controller 11 controls the vertical movement motor 25m, the sliding movement motor 26m, and the rotating motor 27m, etc., based on transporting-purpose transfer reference operation amount information for the support platform 3 of transport origin, to cause the support member 24 to be moved from the travel purpose position to a position near the article W. Next, the operation controller 11 controls the gripper motor 24m to cause the gripping claws 24a to be moved toward and closer to each other (to closer-together positions) to grip or hold the flange portion 6 of the article W. Subsequently, the operation controller 11 controls the vertical movement motor 25m, the sliding movement motor 26m, and the rotating motor 27m, etc., to cause the support member 24 to be moved to the travel purpose position with the article W suspended from the support member 24. Thereby, the article W which was previously supported by the support platform 3 of transport origin is now supported by the support member 24 located in the travel purpose position.

In the delivering travel operation, the operation controller 11 controls the drive motor 22m based on transporting-purpose stop target position information for the support platform 3 specified as the transport destination, to cause the travel portion 22 to travel with the article W suspended therefrom and to stop at the transporting-purpose stop target position.

In the delivering vertical movement operation, the operation controller 11 controls the vertical movement motor 25m, the sliding movement motor 26m, and the rotating motor 27m, etc., based on transporting-purpose transfer reference operation amount information for the support platform 3 of transport destination, to cause the support member 24 to be moved from the travel purpose position to a position near the support platform 3 with the article W suspended from the support member 24. Next, the operation controller 11 controls the gripper motor 24m to cause the gripping claws 24a to be moved away from each other (to farther-apart positions). Thereby, the article W which was previously supported by the support member 24 is now placed on the support platform 3 of transport destination.

Subsequently, the operation controller 11 controls the vertical movement motor 25m, the sliding movement motor 26m, and the rotating motor 27m, etc., to cause the support member 24 to be moved to the travel purpose position.

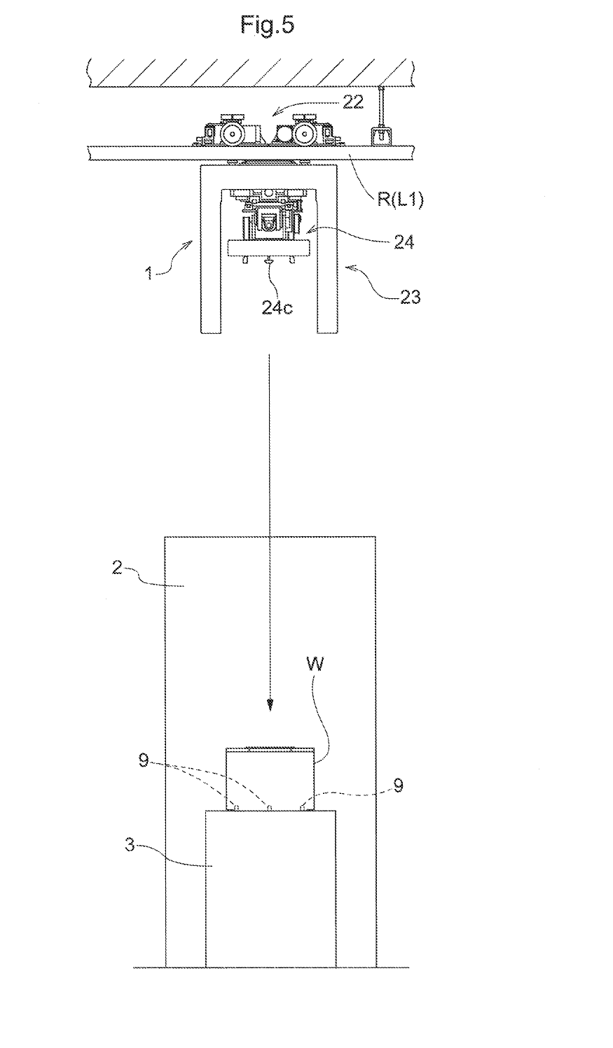

Incidentally, as shown in FIG. 3, the top surface recess 8 is formed in the top surface of the flange portion 6 (i.e. in the top surface of the article W). The top surface recess 8 is configured such that, when the support member 24 is lowered as shown in FIG. 5, a pressing portion 24c provided to the support member 24 can engage the top surface recess 8 from above. For example, when the ceiling transport vehicle 1 lowers the support member 24 in the receiving vertical movement operation, the support member 24 may be horizontally displaced or offset with respect to the article W supported by the support platform 3. Even in such a case, because the pressing portion 24c comes into contact with, and thus is guided by, the inner surface of the top surface recess 8, the horizontal position of the support member 24 is guided to a position suitable for the article W.

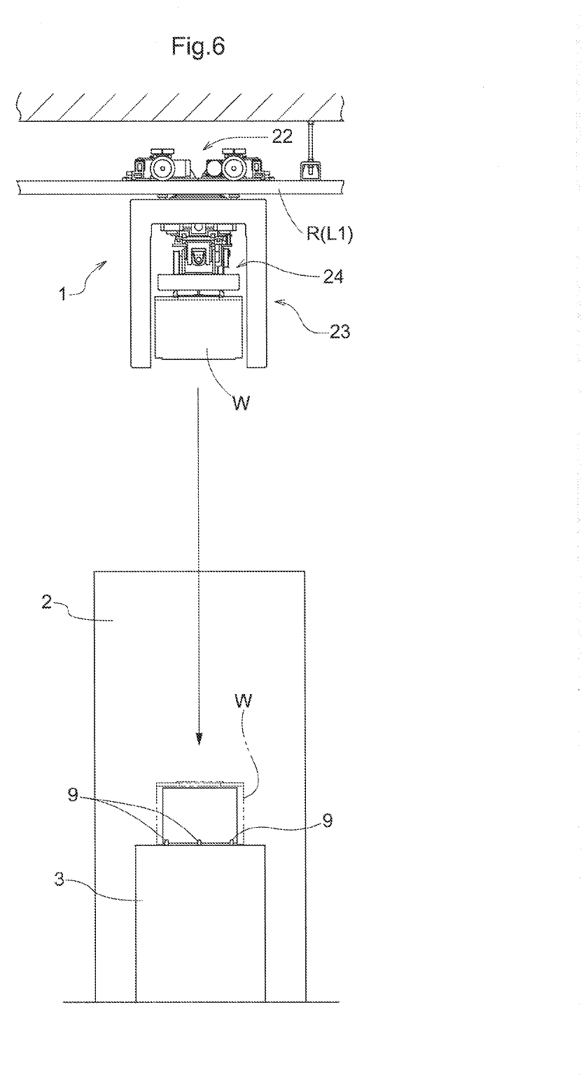

In addition, three bottom surface recesses 7 each of which is a groove are provided or formed in the bottom surface of the article W. As shown in FIG. 6, the bottom surface recesses 7 are provided at such positions that, when the article W is being placed on the support platform 3 of transport destination as shown, positioning members 9 provided to the support platform 3 engage the bottom surface recesses 7 from below. For example, in the delivering vertical movement operation, when the support member 24 is lowered to transfer an article W to the support platform 3, the article W may be horizontally displaced with respect to the proper support position of the support platform 3. Even in such a case, because the positioning members 9 come into contact with the inward surfaces of the bottom surface recesses 7 and thus the article W is moved horizontally, the horizontal position of the article W is corrected to a proper support position of the support platform 3.

Thus, some positional errors or discrepancies that occur during the receiving vertical movement operation or the delivering vertical movement operation can be reduced by the mechanical structures in the support member 24 and the support platform 3. However, as the positional errors or discrepancies increase due to changes and/or wear that occur over time in the ceiling transport vehicles 1, such mechanical structures may not be sufficient to alleviate the errors which may prevent objects such as articles W from being properly transferred. For example, a transporting-purpose stop target position indicated by transporting-purpose stop target position information may become displaced from an ideal transporting-purpose stop target position, due to abrasive wear, etc., in the travel wheels 22a, In addition, the difference between the transporting-purpose transfer reference operation amount indicated by transporting-purpose transfer reference operation amount information and ideal transporting-purpose transfer reference operation amount may gradually increase due to deterioration and/or wear in the vertically moving portion 25 that occurs with the passage of time. It is common to set a time interval for performing periodic inspections, etc., and to make adjustments when these inspections are performed. However, the errors for some ceiling transport vehicles may become large before a periodic inspection is performed due to differences in the operating time, and/or individual differences, among the ceiling transport vehicles 1. Therefore, it is desirable to perform proper adjustments at a proper time for each ceiling transport vehicle 1.

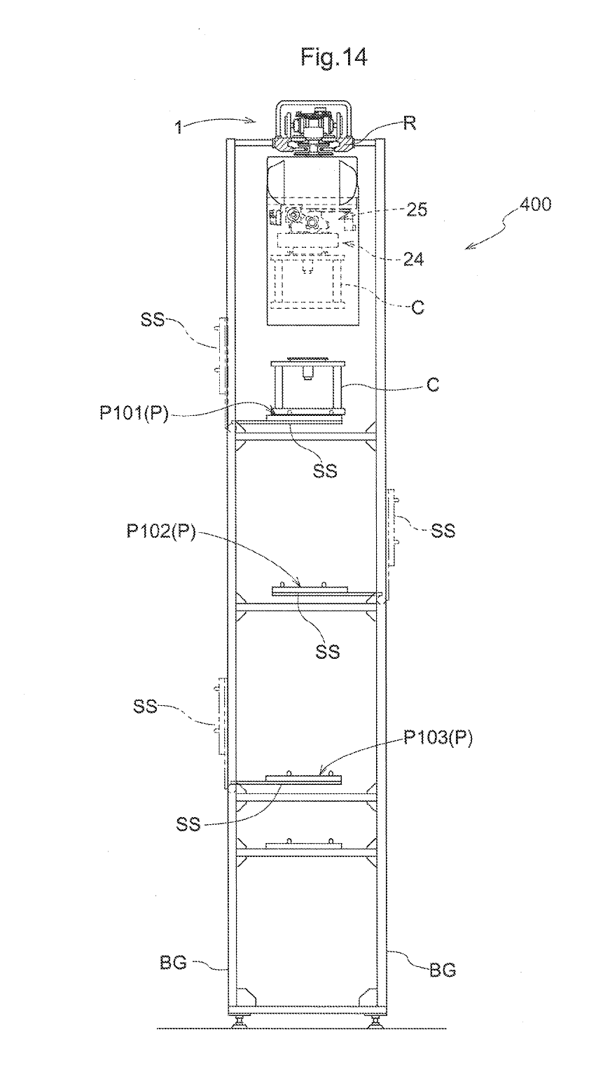

As one attempt to achieve this, it is conceivable to perform adjustments by providing a separate support platform for adjusting purpose (adjusting-purpose support platform for short) that is configured to support an article W at a position located at the height of the actual support platform 3 (i.e., the height from the ground, or the distance from the travel rails R to the support surface of the support platform). See, for example FIG. 14 of the present application. This adjusting-purpose support platform 400 is configured to support a unit C for adjusting purpose (which will be referred to as an adjusting-purpose unit for short and which is used in place of an article and is placed in the adjusting-purpose support platform 400) on support surfaces P (P101-P103) for adjusting purpose (adjusting-purpose support surfaces for short) located at different heights. The adjusting-purpose support platform 400 has vertical frame members BG and support portions SS that span between the vertical frame members BG in this example. Each support portion SS is configured to be pivoted by an actuator (not shown) such that its attitude can be switched or changed between a state in which the adjusting-purpose support surface P extends along the vertical (up and down) direction and a state in which the adjusting-purpose support surface P extends horizontally. However, with such a structure, it is not easy to flexibly set the height of the adjusting-purpose support surface P to correspond to the height of the actual support platform. In addition, when the differences in the heights of different adjusting-purpose support surfaces P are small, any two support portions SSs that are adjacent each other along the vertical direction may interfere with each other so that the structure also makes it difficult to provide adjusting-purpose support surfaces P with small distances between them.

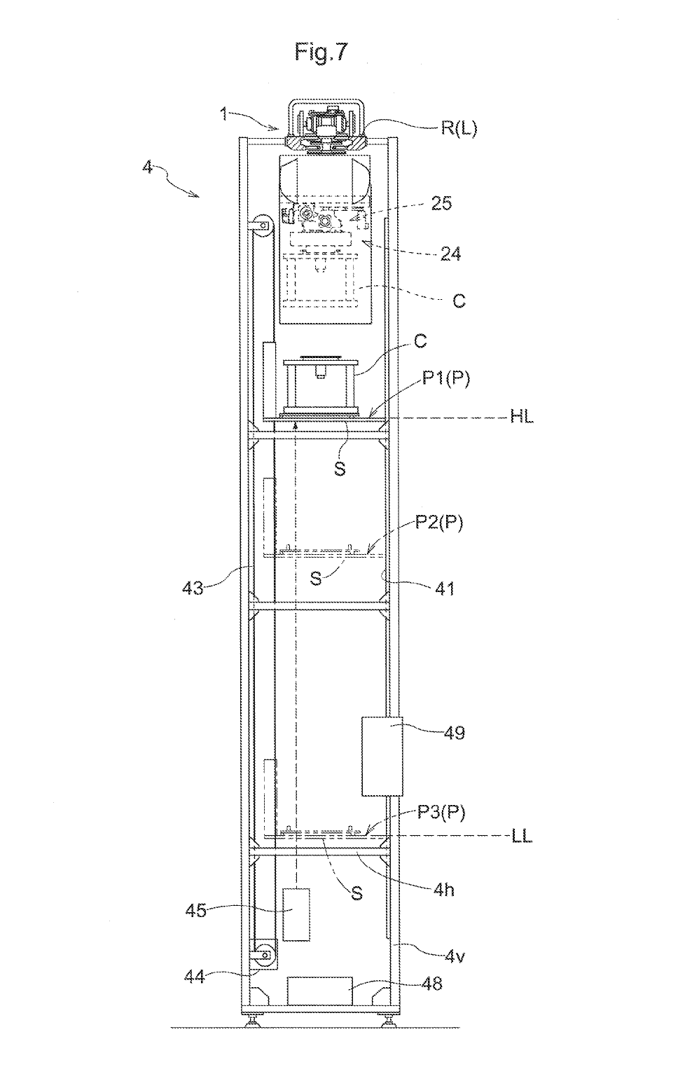

To address this problem, as shown in FIG. 7, in the present embodiment, an adjusting-purpose support platform 4 is used in which an adjusting-purpose support surface P can be placed at heights that can be varied continuously (i.e., the adjusting-purpose support surface is capable of being moved such that a height thereof can be varied continuously) between an upper limit height HL and a lower limit height LL specified in advance. An adjusting-purpose unit C can be placed on the adjusting-purpose support surface P in the same manner in which an article W is placed on a support platform 3.

The adjusting-purpose support platform 4 is provided with one or more guide rails 41 (“the guide rail 41” in the following description for convenience) provided to extend vertically and a belt 43 for vertical movement (vertical movement belt for short). The vertical movement belt 43 is an example of a flexible elongate member. The support portion S is supported at least at one end, along a horizontal direction, by the guide rail 41 and which has the adjusting-purpose support surface P formed (i.e., formed or provided) in a top surface of the support portion S. In the present embodiment, both ends of the support portion S are supported with one end supported by the guide rail 41 and the other end supported by the vertical movement belt 43. The vertical movement belt 43 is actuated by a vertical movement actuator 44. The vertical movement actuator 44 is an electric motor, for example. And the support portion S is raised along the guide rail 41 as the electric motor rotates in a forward direction while the support portion S is lowered along the guide rail 41 as the electric motor rotates in a backward or reverse direction. In other words, the vertical movement actuator 44 is configured to vertically move the support portion S along the guide rail 41.

The position of the support portion S along the vertical direction is detected by a position detecting sensor 45. FIG. 7 shows an example in which the laser range finder is used as the position detecting sensor 45. The laser range finder emits a laser beam to the bottom surface of the support portion S to measure the distance between the laser range finder and the support portion S. Although a laser range finder is used as an example of the position detecting sensor 45 in the present embodiment, an arrangement may be adopted in which the amount of movement of the vertical movement belt 43 is measured by an encoder etc. The detection results obtained by the position detecting sensor 45 are transmitted to an adjusting platform controller 48. The adjusting platform controller 48 controls the operation of the vertical movement actuator 44 to cause the support portion S to be raised and lowered, or vertically moved, based on the detection result obtained by the position detecting sensor 45 in accordance with a command from the second controller H2 (which includes instructions regarding the position (height for adjusting purpose (or adjusting-purpose height)) of the adjusting-purpose support surface P). The adjusting-purpose support surface P is thus placed at an adjusting-purpose height specified in advance in this manner.

The adjusting platform controller 48 causes the support portion S to be vertically moved based on a command from the second controller H2, or on an operation by a worker of a console panel 49 (which is provided to the adjusting platform controller 48). For example, the support portion S may be vertically moved based on an operation by a worker of the console panel 49. Alternatively, the support portion S may be vertically moved automatically based on commands issued by a computer program etc. which is stored in the second controller H2. Thus, in the case the support portion S is arranged to be vertically moved automatically, it is also possible to automate the entire process of adjusting the transporting-purpose profile information.

Note that it is preferable that the adjusting-purpose height is specified to correspond to the height of the article support surface (see FIG. 5) where an article W is placed on the support platform 3. If the adjusting-purpose height is specified to correspond to the height of the article support surface (see FIG. 5) where an article W is placed on the support platform 3, adjustments that are equivalent to those made using an actual support platform 3 can be performed. Note that the height of the article support surfaces may not necessarily be the same for all of the plurality of support platforms 3 provided to the article transport facility. The plurality of support platforms 3 may include a number of different kinds of support platforms 3 having article support surfaces of different heights. In such a case, the ceiling transport vehicles 1 transport articles W to different kinds of support platforms 3. Therefore, if more than one adjusting-purpose heights are specified based on the heights of the article support surfaces, transporting-purpose profile information can be adjusted properly based on the heights of the article support surfaces of the different kinds of support platforms 3.

In addition, it is preferable that the adjusting-purpose height is specified based on the amount of operation of the vertically moving portion 25 when the support member 24 is moved from the set raised position specified in advance to a set lowered position for placing the article W on the support platform 3. Note that the height of each article support surface depends on the position of the article support surface of the support platform 3. Although the set lowered position is basically the same for the support platforms 3 of the same kind; however, since the position of the article support surface may be different for different support platforms 3, a given article transport facility may have more than one set lowered positions. On the other hand, since the set raised position is a position used as a reference when the ceiling transport vehicle 1 travels, there is only one set raised position for any given article transport facility, as a general rule.

As described above, transporting-purpose transfer reference operation amount information includes transporting-purpose profile information. While the transporting-purpose transfer reference operation amount information includes the amount of operation of the support member 24 when moving the support member 24 with respect to the travel portion 22, this amount of operation represents at least the amount of operation of the vertically moving portion 25. Information on the amounts of operations of the support member 24 and the vertically moving portion 25 for transferring an article W depends on the distance between the top surface (article support surface) of the support platform 3 and the set raised position.

The distance between the floor surface and an article support surface is almost constant irrespective of the location in which an article transport facility is installed since the floor surface serves as a reference height, However, the height of the ceiling with respect to the floor surface can vary. The brackets for suspending from the ceiling the travel rails R which suspends and supports the ceiling transport vehicles 1 are generally of standard dimensions specified by the industry standards. Therefore, the distance between an article support surface and the set raised position may vary depending on the location at which the article transport facility is installed. In addition, the amount of operation of the support member 24 and the vertically moving portion 25 may be specified in terms of, among other possibilities, a fed-out amount of a belt, etc., which is used to suspend the support member 24 from the travel portion 22, or the number of rotations of a pulley which is rotated when feeding out the belt. And such fed-out amount and number of rotations may vary depending on the specification of each ceiling transport vehicle 1 even if the distance of movement (amount of operation) of the support member 24 is the same. For example, when a number of different kinds of ceiling transport vehicles 1 are used in one article transport facility, a plurality of transporting-purpose transfer reference operation amounts may exist for one support platform 3. Thus, it is preferable that the adjusting-purpose height is specified based on the amount of operation of the vertically moving portion 25 when the support member 24 is moved from the set raised position specified in advance to a set lowered position for placing the article W on the support platform 3.

It is preferable that the adjusting-purpose support surface P can be placed such that the transporting-purpose profile information can be adjusted properly even if the distance between the top surface (article support surface) of the support platform 3 and the set raised position described above and the amount of operation of the support member 24 and the vertically moving portion 25 (e.g., fed-out amount or the number of rotations) vary. Therefore, it is preferable that each adjusting-purpose height which specifies the height of the adjusting-purpose support surface P is specified based on at least one of the height of an article support surface and the amount of operation of the vertically moving portion 25 when the support member 24 is moved from the set raised position to the set lowered position.

Adjustment of transporting-purpose profile information is described next. For example, the first controller H1 issues a command (a leave command) to cause the vehicle 1 to leave the first area E1 and into the second area E2. the ceiling transport vehicle 1 (adjusting target vehicle) that is to be subjected to the adjustment. The ceiling transport vehicle 1 to be subjected to the adjustment (i.e., the adjusting target vehicle) may be specified or selected manually by a worker, or may be specified or selected by the first controller H1 or other controller(s) based on management information for the ceiling transport vehicles 1. The operation controller 11 of the ceiling transport vehicle 1 specified as the adjusting target vehicle causes the ceiling transport vehicle 1 (adjusting target vehicle) to enter a second path L2 through a branching portion J1 based on a leave command from the first controller H1. The operation controller 11 of the ceiling transport vehicle 1 (adjusting target vehicle) causes the ceiling transport vehicle 1 to travel to an adjusting-purpose stop target position and to stop there based on adjusting-purpose stop target position information for the adjusting-purpose support platform 4 stored in its profile storage 12.

In the present embodiment, the ceiling transport vehicle 1 (adjusting target vehicle) operates in the second area E2 based on commands from the second controller H2. The second controller H2 transmits an adjustment command to the ceiling transport vehicle 1 (adjusting target vehicle). In response to the adjustment command from the second controller H2, the operation controller 11 of the ceiling transport vehicle 1 (adjusting target vehicle) performs an adjusting operation using an adjusting-purpose unit C (an adjusting-purpose device) as described below. Further, the operation controller 11 updates the transporting-purpose profile information stored in the profile storage 12 based on the result obtained in this adjusting operation.

Once the adjustment is completed, the ceiling transport vehicle 1 (adjusting target vehicle) is ready to transport an article W based on a command from the first controller H1. The ceiling transport vehicle 1 may notify the first controller H1 of the fact that the adjustment is completed. Or the second controller H2 may notify the first controller H1 of this fact. Based on a request from a controller such as a production managing controller that is superordinate to the first controller H1, the first controller H1 transmits a transport command to the ceiling transport vehicle 1, specifying a support platform 3 (support platform) to which the ceiling transport vehicle 1 (adjusting target vehicle) is to be dispatched. The operation controller 11 of the ceiling transport vehicle 1 causes the ceiling transport vehicle 1 (adjusting target vehicle) to travel to the first area E1 from the second area E2 and to transport an article W based on the transport command.

An example of a procedure for adjusting transporting-purpose profile information is described next. In the present embodiment, the adjustment is performed by the ceiling transport vehicle 30 receiving, or picking up, the adjusting-purpose unit C (adjusting-purpose device) from the adjusting-purpose support platform 4 in place of an article W and transferring, or delivering, it to the adjusting-purpose support platform 4. It is more preferable that, after receiving the adjusting-purpose unit C, the ceiling transport vehicle 1 travels some distance while suspending and supporting the adjusting-purpose unit C, and transfers the adjusting-purpose unit C to the adjusting-purpose support platform 4 placed at a height different from the height when the ceiling transport vehicle 1 received the adjusting-purpose unit C. The adjusting-purpose unit C (adjusting-purpose device) obtains data for adjusting purpose (or adjusting-purpose data for short) when it is vertically moved by the vertically moving portion 25 of the ceiling transport vehicle 1 (adjusting target vehicle). The errors in vertical movement, rotation, and sliding movement of the support member 24 can be calculated from the adjusting-purpose data. And any error in the transport-purpose stop position information can be calculated based on the amount of operation by the ceiling transport vehicle 1 as it travels while suspending and supporting the adjusting-purpose unit C and the adjusting-purpose data obtained by the adjusting-purpose unit C. The adjusting-purpose unit C calculates the transporting-purpose profile information (profile information for updating or updating-purpose profile data for short) for the adjusting target vehicle and transmits to the adjusting target vehicle the transporting-purpose profile information as data for updating purpose (or updating-purpose data). Note that updating-purpose data does not have to be the transporting-purpose profile information but may be information that provides any difference from the original transporting-purpose profile information.

In the second area E2, the adjusting-purpose support platform 4 which has the adjusting-purpose support surface P on which the adjusting-purpose unit C can be placed in the same manner in which an article W is placed on a support platform 3. As described above, some support platforms 3 located in the first area E1 may be of different heights from the ground from other support platforms 3. Therefore, in the adjustment control performed in the second area, it is preferable that the adjusting-purpose unit C is placed on adjusting-purpose support surfaces P (P1, P2, P3 . . . ) at different heights one surface at a time, and obtains adjusting-purpose data when vertically moved with respect to each of the adjusting-purpose support surfaces P (P1, P2, P3 . . . ). Note that although a plurality of adjusting-purpose support surfaces P (P1, P2, P3 . . . ) are discussed for convenience, these plurality of surfaces may be defined by one physical surface on the support portion S that can be moved to different heights as is the case in the present embodiment.

The adjusting-purpose unit C is vertically moved by the vertically moving portion 25 from various adjusting-purpose support surfaces P (P1, P2, P3 . . . ) at different heights one surface P at a time; and the transporting-purpose profile information is calculated based on the adjusting-purpose data obtained when the adjusting-purpose unit C is vertically moved from each of these heights. In the present embodiment, the adjusting target vehicle is configured to travel along second paths L2 and to transfer the adjusting-purpose unit C to any of the adjusting-purpose support surfaces P at different heights. The adjusting-purpose unit C obtains adjusting-purpose data for each of the adjusting-purpose support surfaces P at a plurality of different heights.

For example, the adjusting-purpose unit C is placed in the adjusting-purpose support platform 4 with an adjusting-purpose support surface P (for example, first adjusting-purpose support surface P1) at one of the heights of a first adjusting-purpose support surface P1, a second adjusting-purpose support surface P2, and a third adjusting-purpose support surface P3 shown in FIG. 7, serving as a storage location. (That is, the adjusting-purpose unit C is placed on the first adjusting-purpose support surface P1 in this example.) The ceiling transport vehicle 1 that is specified an adjusting target vehicle performs the receiving travel operation and receiving vertical movement operation on the adjusting-purpose unit C placed on the first adjusting-purpose support surface P1, and performs the delivering vertical movement operation on the adjusting-purpose unit C to place it on the support portion S whose height was changed while the adjusting-purpose unit C was suspended from and supported by the ceiling transport vehicle 1 (i.e., with respect to, for example, second adjusting-purpose support surface P2). The adjusting-purpose unit C obtains adjusting-purpose data each time one of these operations is performed to calculate the transporting-purpose profile information for the adjusting target vehicle.

The support member 24 is then temporarily raised to the set raised position with the adjusting-purpose unit C left on the second adjusting-purpose support surface P2. Next, the ceiling transport vehicle 1 performs the receiving vertical movement operation on the adjusting-purpose unit C placed on the second adjusting-purpose support surface P2, and performs the delivering vertical movement operation on the adjusting-purpose unit C to place it on the support portion S whose height was changed while the adjusting-purpose unit C was suspended from and supported by the ceiling transport vehicle 1 (i.e., to place it on, for example, the third adjusting-purpose support surface P3). The adjusting-purpose unit C, as with the previous step, obtains adjusting-purpose data each time one of these operations is performed to calculate the transporting-purpose profile information for the adjusting target vehicle. The support member 24 is then temporarily raised to the set raised position with the adjusting-purpose unit C left on the third adjusting-purpose support surface P3. Finally, the ceiling transport vehicle 1 performs the receiving vertical movement operation on the adjusting-purpose unit C placed on the third adjusting-purpose support surface P3, and performs the delivering vertical movement operation on the adjusting-purpose unit C to place it on the support portion S whose height was changed while the adjusting-purpose unit C was suspended from and supported by the ceiling transport vehicle 1 (i.e., to place it on, for example, the first adjusting-purpose support surface P1). The adjusting-purpose unit C, as with the previous step, obtains adjusting-purpose data each time one of these operations is performed to calculate the transporting-purpose profile information for the adjusting target vehicle. Note that, after performing the receiving vertical movement operation on the adjusting-purpose unit C placed on the third adjusting-purpose support surface P3, and after performing a delivering travel operation by traveling along a learning-purpose path Lt (see FIG. 1) provided in the second area E2, the delivering vertical movement operation may be performed to place the adjusting-purpose unit C on the support portion S (first adjusting-purpose support surface P1).

With this series of transfer operations and calculations defined as one cycle or loop, the same transfer operations and calculations are repeated a plurality of times. For example, in order to take measurement errors, etc., into consideration, three cycles of the transfer operations and calculations are repeated to determine the transporting-purpose profile information for updating purpose by using averages and/or standard deviations. Naturally, if there is sufficient accuracy in the data, the entire process may be completed by performing only one cycle.

In the example described above, the delivering travel operation is performed only once at the end by the ceiling transport vehicle 1 traveling along the learning-purpose path Lt. However, the delivering travel operation may be performed each time the height of the adjusting-purpose support surface P is changed, by the ceiling transport vehicle 1 by traveling along the learning-purpose path Lt. Now suppose that the adjusting-purpose unit C is placed in the adjusting-purpose support platform 4 with the first adjusting-purpose support surface P1 serving as a storage location, as with the case of the example above. (That is, suppose that the adjusting-purpose unit C is placed on the first adjusting-purpose support surface P1 in this example.) First, the ceiling transport vehicle 1 that is specified as the adjusting target vehicle performs the receiving travel operation and the receiving vertical movement operation on the adjusting-purpose unit C placed on the first adjusting-purpose support surface P1, and performs the delivering vertical movement operation on the adjusting-purpose unit C to place it on the support portion S whose height was changed while the adjusting-purpose unit C was suspended from and supported by the ceiling transport vehicle 1 (i.e., to place it on, for example, the second adjusting-purpose support surface P2) after performing the delivering travel operation by traveling through the learning-purpose path Lt. to the support portion S. The adjusting-purpose unit C obtains adjusting-purpose data when each of these operations is performed to calculate the transporting-purpose profile information for the adjusting target vehicle.

Next, the ceiling transport vehicle 1 performs the receiving vertical movement operation on the adjusting-purpose unit C placed on the second adjusting-purpose support surface P2 and then performs the delivering travel operation and the delivering vertical movement operation to place the adjusting-purpose unit C on the third adjusting-purpose support surface P3. The adjusting-purpose unit C, as with the previous step, obtains adjusting-purpose data when each of these operations is performed to calculate the transporting-purpose profile information for the adjusting target vehicle. Finally, the ceiling transport vehicle 1 performs the receiving vertical movement operation on the adjusting-purpose unit C placed on the third adjusting-purpose support surface P3 and then performs the delivering travel operation and the delivering vertical movement operation to place the adjusting-purpose unit C on the first adjusting-purpose support surface P1. The adjusting-purpose unit C, as with the previous step, obtains adjusting-purpose data when each of these operations is performed to calculate the transporting-purpose profile information for the adjusting target vehicle. With this series of transfer operations and calculations defined as one cycle or loop, the same transfer operations and calculations may be repeated a plurality of times as with the case described above. Naturally, if there is sufficient accuracy in the data, the entire process may be completed by performing only one cycle.

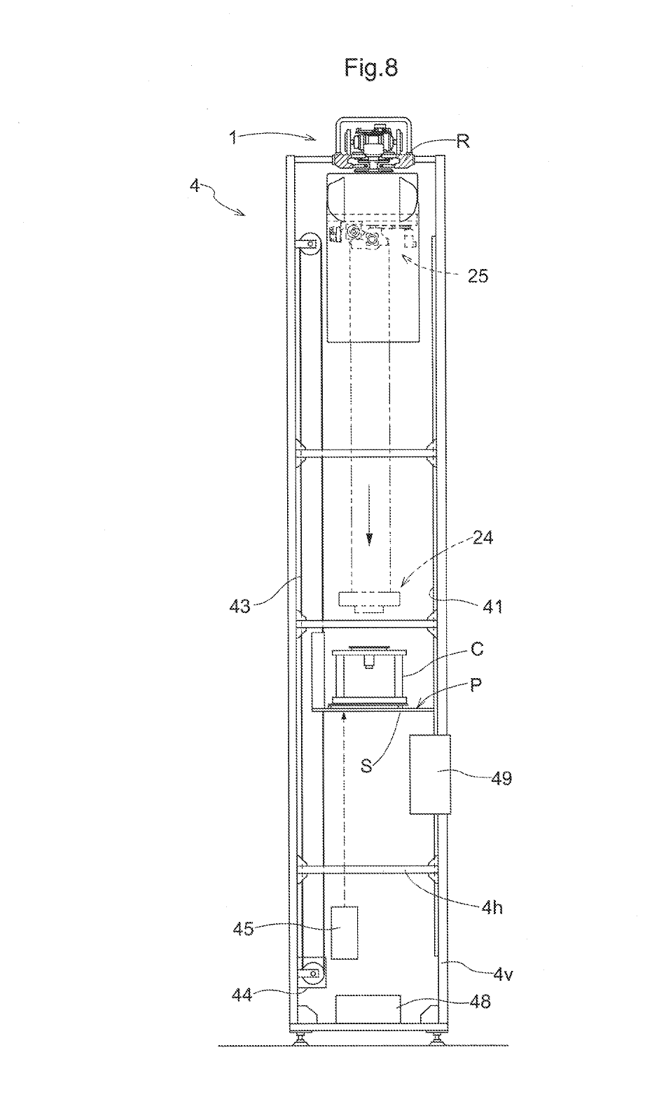

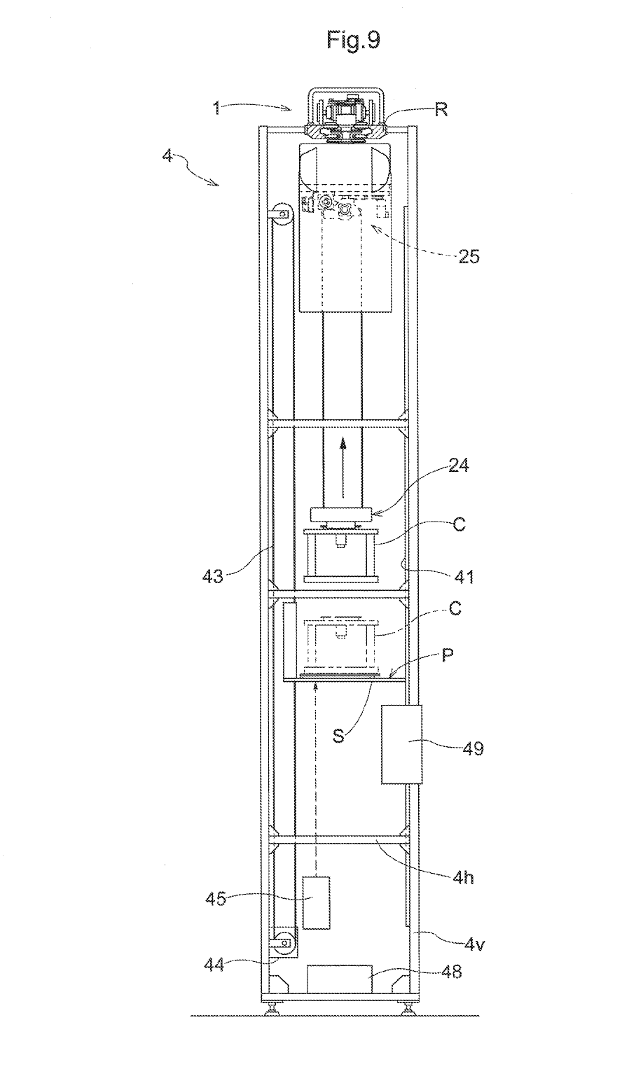

FIGS. 8 and 9 show an example of how the ceiling transport vehicle 1 receives, or picks up, the adjusting-purpose unit C from the adjusting-purpose support platform 4 in place of an article W. In addition, the enlarged view of FIG. 10 shows the positional relationship between the adjusting-purpose support surface P and the adjusting-purpose unit C when the adjusting is being performed. As described above, each ceiling transport vehicle 1 can support the adjusting-purpose unit C in place of an article W, and can transport the adjusting-purpose unit C in the same manner that it transports an article W. As shown in FIG. 10, a unit flange portion 13 is provided in the upper end portion of the adjusting-purpose unit C as with an article W. And this unit flange portion 13 is suspended from and supported by the support member 24 of any of the ceiling transport vehicles 1. A unit main body portion 14 is provided below the unit flange portion 13 and at a location that corresponds to the location of the holding portion 5 of an article W. A distance sensor or a range finder (RNG-FND) 18 and an image sensor (IM-SEN) 19 are supported by the unit main body portion 14.

As with an article W, three bottom surface recesses 7 each of which is a groove recessed upward are provided or formed in the bottom surface of the unit main body portion 14 (i.e., the bottom surface of adjusting-purpose unit C). In addition, as with the support platform 3, positioning members 9 are provided in the top surface of the adjusting-purpose support platform 4 at locations at which the positioning members 9 engage the adjusting-purpose unit C from below. Thus, even if the adjusting-purpose unit C is horizontally displaced with respect to the proper support position of the support platform 3 when the adjusting-purpose unit C is transferred into the adjusting-purpose support platform 4, the horizontal position of the adjusting-purpose unit C is corrected to a proper support position because the positioning members 9 come into contact with the inward surfaces of the unit bottom surface recesses 7b and thus the adjusting-purpose unit C is moved horizontally. This arrangement allows the adjusting-purpose unit C to be always placed in a specified position on the support portion S even if there is any positional error or deviation with respect to the support portion S located at any desired height in the adjusting-purpose support platform 4, during the delivering travel operation and the delivering vertical movement operation performed on the adjusting-purpose unit C. Therefore, the receiving travel operation and receiving vertical movement operation with respect to the adjusting-purpose support platform 4 can be subsequently performed properly.

In addition, a top surface recess (not shown) that is generally formed in a conical shape that is recessed downward is formed in the top surface of the unit flange portion 13 (i.e., in the top surface of adjusting-purpose unit C). The unit top surface recess is configured such that the pressing portion 24c provided to the support member 24 engages the unit top surface recess from above when the support member 24 is lowered as shown in FIG. 8. For example, when the ceiling transport vehicle V lowers the support member 24 in the receiving vertical movement operation, the support member 24 may be horizontally displaced with respect to the adjusting-purpose unit C received and supported by the adjusting-purpose support platform 4. Even if that happens, the pressing portion 24c comes into contact with, and is thus guided by, the inner surface of the unit top surface recess; thus, the support member 24 is guided along the horizontal direction to a suitable position for the adjusting-purpose unit C.

As shown in FIG. 4, each ceiling transport vehicle 30 is provided with an adjusting-purpose communication portion 15 for transmitting and receiving various information to and from a unit communication portion 16 of the adjusting-purpose unit C through wireless communication. In addition, the adjusting-purpose unit C is provided with the distance sensor 18, the image sensor 19, the unit communication portion 16, and a unit controller (UNIT-CTRL) 17. The distance sensor 18 is, for example, a laser range finder and measures the distance between the adjusting-purpose support surface P and the bottom portion of adjusting-purpose unit C, as described below with reference to FIG. 10. The image sensor 19 is a two-dimensional image sensor, for example, and is a sensor for capturing an image of a “detected member” M (which is preferably the adjusting-purpose support surface P) provided to the adjusting-purpose support platform 4. The unit communication portion 16 has an antenna and a communication-control circuit, and transmits and receives various information to and from the ceiling transport vehicle 1 by short-range wireless communication. The unit controller 17 has a microcomputer etc. as its core component, controls operations of the distance sensor 18, the image sensor 19, and the unit communication portion 16, performs an image recognition of the image of the detected member M captured by the image sensor 19, and calculates updating-purpose data, such as transporting-purpose profile information for updating, based on the result of the image recognition.

As shown in FIG. 8, when lowering the adjusting-purpose unit C toward the adjusting-purpose support surface P, the ceiling transport vehicle 1 first causes the vertical movement motor 25m to operate to feed out the spool belts 25b until the adjusting-purpose unit C rests on (i.e., is placed on) the adjusting-purpose support surface P. The fed-out amount of a spool belt 25b (i.e. the amount of the spool belt 25b that has been fed out of a winding member 25a) is measured and counted as the number of pulses by an encoder as described above. Whether or not the adjusting-purpose unit C has rested on the adjusting-purpose support surface P is determined by the vertically moving portion 25 or the operation controller 11 based, for example, on a change in the tension in a spool belt 25b. After determining that the adjusting-purpose unit C has rested on the adjusting-purpose support surface P, the ceiling transport vehicle 1 causes the vertical movement motor 25m to operate to begin to spool the spool belt 25b onto a winding member 25a at a low speed.

The spooling of the spool belt 25b causes the adjusting-purpose unit C to be lifted from the adjusting-purpose support surface P, as shown in FIG. 10. The distance between the adjusting-purpose support surface P and the bottom portion of the adjusting-purpose unit C is measured by the distance sensor 18, and the result of the measurement is transmitted to the ceiling transport vehicle 1. When this distance enters a tolerance range for adjusting-purpose separation distance D specified in advance, the spooling of the spool belt 25b is stopped. This places the adjusting-purpose unit C at a position where it is suspended from and supported by the support member 24 and is spaced apart from the adjusting-purpose support surface P by the adjusting-purpose separation distance D. The number of pulses with tension in the spool belt 25b is obtained as the fed-out amount of the spool belt 25b, and is transmitted to the adjusting-purpose unit C. Note that the adjusting-purpose separation distance D is about 5-10 mm, for example, with a permitted error or tolerance range of about plus or minus 2.5-3 mm. For example, when the adjusting-purpose separation distance D is 5 mm and the permitted error is ±2.5 mm, the adjusting-purpose unit C will be suspended from, and supported by, the support member 24 with the distance between the adjusting-purpose support surface P and the bottom portion of adjusting-purpose unit C being within a range between 2.5 mm and 7.5 mm. In this state, the image sensor 19 captures an image of the detected member M.

The detected member M is provided with, for example, a two-dimensional code. The adjusting-purpose unit C (or more specifically, the unit controller 17) determines the amounts of displacement of the detected member M with respect to the image sensor 19 along the travel direction, a lateral width direction, and about a vertical axis, based on the size, the angle, the position, etc., of the image of the detected member M captured with the image sensor 19. Since the position of the image sensor 19 is fixed in the adjusting-purpose unit C, the amounts of displacement of the detected member M with respect to the adjusting-purpose unit C along the travel direction, the lateral width direction, and about the vertical axis can be determined. Note that, in lieu of providing the distance sensor 18, the unit controller 17 may calculate the distance between the adjusting-purpose support surface P and the bottom portion of adjusting-purpose unit C from the size of the image of the detected member M captured by the image sensor 19. In addition, even when the distance sensor 18 is provided, since some error is permitted in the distance as described above, this distance may be corrected based on the size of the image of the detected member M captured by the image sensor 19 to make the fed-out amount of the spool belt 25b more accurate.

For example, when an article transport facility is newly built, transporting-purpose profile information is provided to a ceiling transport vehicle 1 (reference transport vehicle) which serves as a reference for all the ceiling transport vehicles 1 of the article transport facility. This transporting-purpose profile information is profile information (reference profile information) that serves as a reference for all other ceiling transport vehicles 1 of this article transport facility. The reference profile information is generated (in this reference profile maintenance phase) by actually transporting and transferring an article W (or the adjusting-purpose unit C in the case of the adjusting-purpose support plat form 4) (or a reference article used in place of one or both) to all the support platforms including the adjusting-purpose support platform (i.e., all of the support platforms 3 in the first area E1 and the adjusting-purpose support platform 4 in the second area E2).

If and when a ceiling transport vehicle 1 other than the reference transport vehicle is added to the article transport facility, the reference profile information is stored in the profile storage 12 of the ceiling transport vehicle 1 that is being added. Next, the ceiling transport vehicle 1 is caused to travel to the second area E2 where the adjustment described above is performed. The receiving travel operation, the receiving vertical movement operation, the delivering travel operation, and the delivering vertical movement operation performed as a part of the adjustment are performed based on the reference profile information; therefore, the individual differences between the reference transport vehicle and the ceiling transport vehicle 1 being added are extracted as difference data. Transporting-purpose profile information that is unique to the ceiling transport vehicle 1 being added is generated based on the reference profile information and the difference data, and is stored its profile storage 12. The ceiling transport vehicle 1 to which unique transporting-purpose profile information is stored is then deployed to the first area E1.

After the normal operation of the article transport facility is started, The ceiling transport vehicle 1 (adjusting target vehicle) that requires an adjustment is caused to move out of the first area E1 and into the second area E2 where an adjustment described above is performed. Once the adjustment is completed, new transporting-purpose profile information is stored in the profile storage 12 of the adjusting target vehicle. The ceiling transport vehicle 1 for which the adjustment completed is again deployed to the first area E1.

### OTHER EMBODIMENTS

Other embodiments are described next. Note that any arrangement and feature of each embodiment described below does not have to be used or incorporated by itself but may be combined with any arrangement and feature of any other embodiment as long as such combination does not give rise to a contradiction.

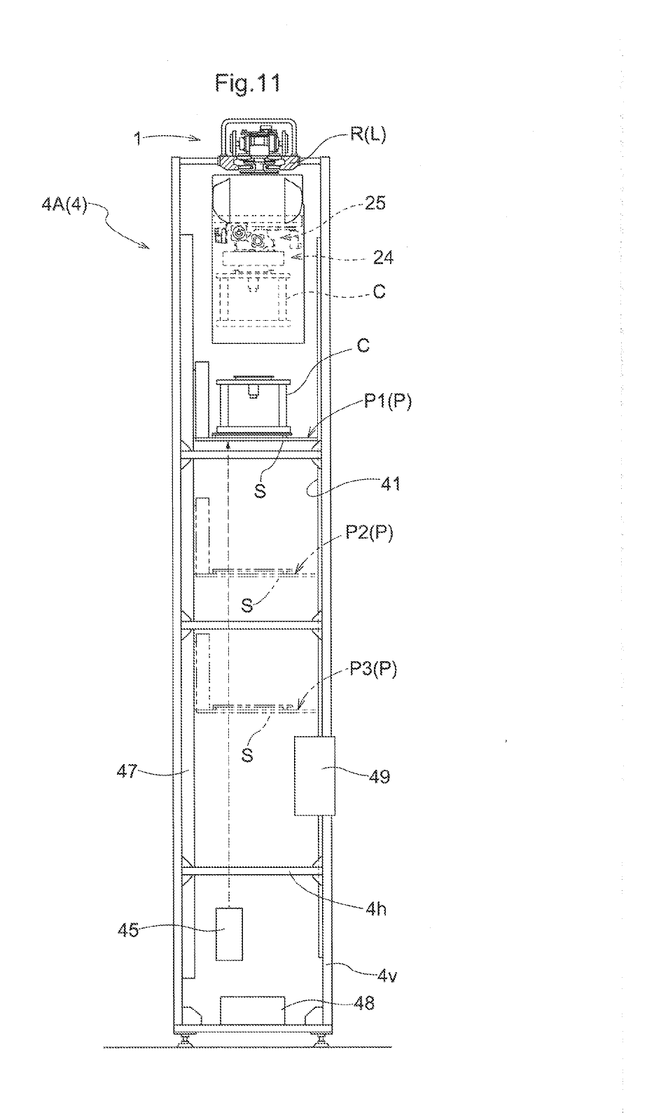

(1) In the embodiment described above, an example is described in which the adjusting-purpose support platform 4 is provided with the vertical movement belt 43 which is moved by the vertical movement actuator 44, and in which the support portion S is vertically moved as the result of the fact that it is supported by the vertical movement belt 43 and the guide rail 41. However, as shown in FIG. 11, arrangements may be made such that the adjusting-purpose support platform 4 (4A) is provided with an electric cylinder or a linear motor 47 having a large stroke length and such that the support portion S is vertically moved as the result of the fact that it is supported by the electric cylinder 47 and the guide rail 41. Note that it is also possible to have an arrangement in which, instead of providing the electric cylinder 47, a worker operates a wheel etc., to manually move the support portion S vertically.

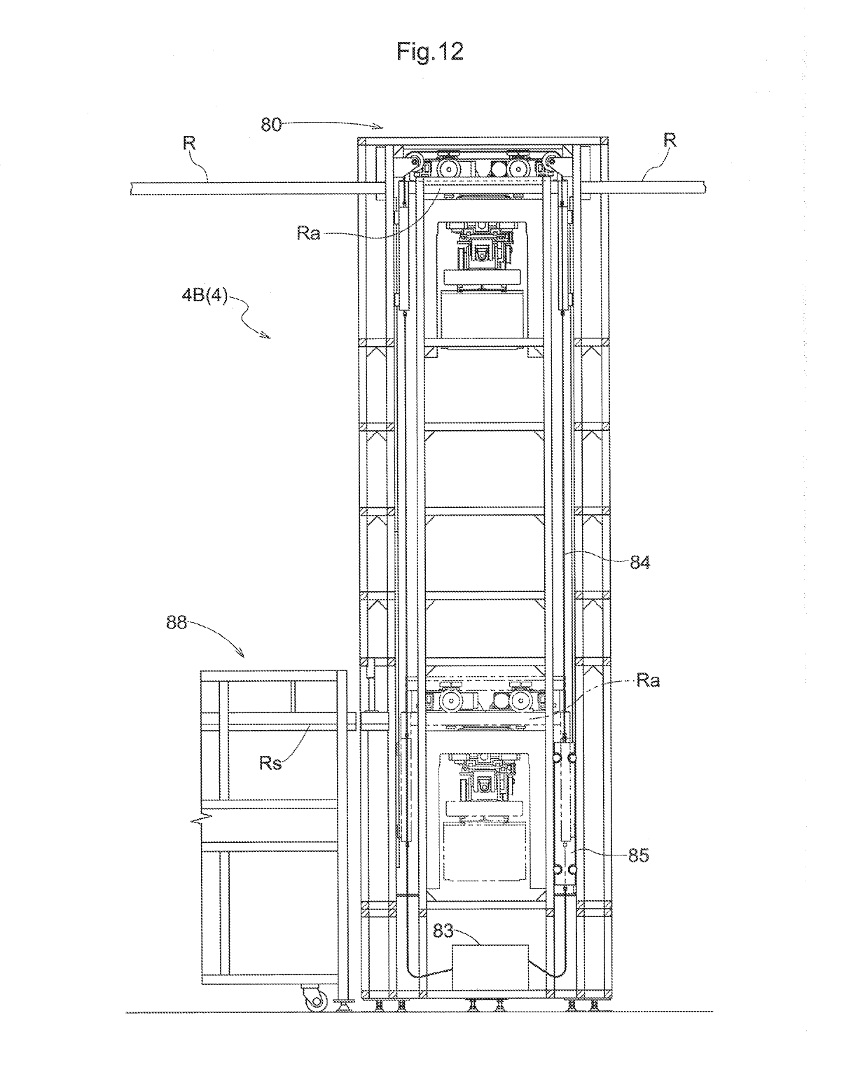

(2) The ceiling transport vehicles 1 are often lowered to the ground side when performing maintenance work such as an inspection and a repair, in consideration of work efficiency and safety. For this reason, a maintenance lifter 80 (a vertically moving device for maintenance purpose or maintenance-purpose vertically moving device for short) as shown in FIG. 12 is often provided in the article transport facility for lowering the ceiling transport vehicle 1 to the ground side, i.e., for removing it to the floor side. The ceiling transport vehicle 1 shown in FIG. 12 with phantom lines is the vehicle 1 when it has been lowered to the ground side by the maintenance lifter 80. The maintenance lifter 80 is provided with lifter rails Ra that can extend in alignment with the travel rails R to form a travel path L. The lifter rails Ra can be vertically moved between the ground side shown with phantom lines and the ceiling side at which the lifter rails Ra are in alignment with the travel rails R, by means of a vertically moving mechanism of a traction type that has a electric motor 83, cables 84, and a balance weight 85. The ceiling transport vehicle 1 lowered to the ground side by lowering the lifter rails Ra while the travel wheels 22a are supported on the lifter rails Ra and the ceiling transport vehicle 1 is suspended from, and supported by, the lifter rails Ra.

When the lifter rails Ra are lowered to the position shown in FIG. 12 with phantom lines, the lifter rails Ra form a path in alignment with carriage side rails Rs provided in a carriage 88. When the ceiling transport vehicle 1 is moved to the carriage 88 side, the ceiling transport vehicle 1 is in a position where its travel wheels 22a are supported on the carriage side rails Rs and the ceiling transport vehicle 1 is suspended from and supported by the carriage side rails Rs. The ceiling transport vehicle 1 can be carried away by moving the carriage 88 in this state.

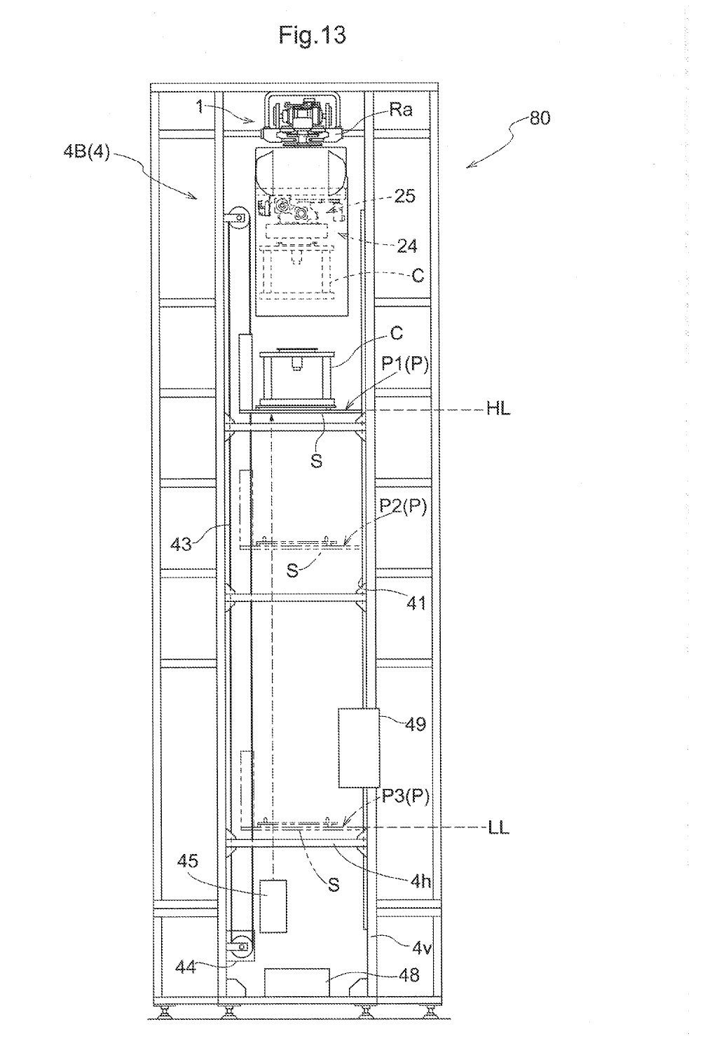

If an adjusting-purpose support platform 4 is provided separately from such a maintenance lifter 80 (at a position different from where the maintenance lifter 80 is in plan view as shown in FIG. 1), then this may reduce the usable area in the article transport facility. The space necessary for the purpose of maintenance work can be reduced if an adjusting-purpose support platform 4B (4) and a maintenance lifter 80 are provided together as shown in FIG. 13. Note that FIG. 13 shows the maintenance lifter 80 as seen along a direction along the travel direction Y. If an adjusting-purpose support platform 4B (4) and a maintenance lifter 80 are provided together, then when performing an inspection or a repair of a ceiling transport vehicle 1, an adjustment of the transporting-purpose profile information can also be performed at that time. Thus, the amount of time in which the ceiling transport vehicle 1 is away from the first area E1 for maintenance and adjustment, etc., can be reduced so that any reduction in the operational efficiency of the ceiling transport vehicle 1 can also be reduced. Note that, although the maintenance lifter 80 may be located in the looped learning-purpose path Lt as shown in FIG. 1, it may be located at or near an end of a path that extends to the dead end after branching off from the primary path Lp at the branching portion J1.

(3) In the embodiment described above, an example is described in which the adjusting-purpose unit C forms an adjusting-purpose device by itself, and in which the unit controller 17 of the adjusting-purpose unit C calculates the transporting-purpose profile information. However, the adjusting-purpose device located in the second area E2 may be a combination of an adjusting-purpose unit C and an adjusting-purpose controller (not shown) fixedly installed on the ground side. In this case, it is preferable that the adjusting-purpose unit C and the adjusting-purpose controller communicate through wireless communication.

(4) In addition, an arrangement disclosed in any of the embodiments described above can also be used in combination with any arrangement disclosed in any other embodiment unless inconsistency arises. All embodiments disclosed in the present description regarding any arrangement are for illustration purpose only with regard to all respects. Therefore, it is possible to make various suitable changes without departing from the spirit of the present disclosure.

### SUMMARY OF EMBODIMENTS

The article transport facility described above is briefly summarized next.

In one embodiment, an article transport facility invented in light of the above comprises:

one or more travel rails supported by a ceiling;

a plurality of support platforms provided on a ground side and along the one or more travel rails;

an article transport vehicle which is suspended from and supported by the one or more travel rails, and is configured to travel along a travel path defined by the one or more travel rails, to suspend and support an article, and to transport the article from one of the plurality of support platforms that serves as a transport origin to another of the plurality of support platforms that serves as a transport destination, wherein the ceiling transport vehicle has a travel portion configured to travel along the travel path, a support member which is supported by the travel portion and which is configured to hold, suspend, and support, the article, a vertically moving portion configured to vertically move the support member with respect to the travel portion when the travel portion is at rest, and a profile storage configured to store transporting-purpose profile information which includes at least information on an amount of operation of the support portion and the vertically moving portion for transferring an article at each of the plurality of support platforms (to or from each of the plurality of support platforms);

an adjusting-purpose device which is used for a purpose of adjusting the transporting-purpose profile information;

an adjusting-purpose support platform which includes an adjusting-purpose support surface on which the adjusting-purpose device can be placed in a same manner in which an article is placed on a support platform,

wherein the adjusting-purpose device is:
(a) capable of being suspended from and supported by the support member in a same manner in which an article is suspended from and supported by the support member;
(b) capable of being placed on a support platform by the article transport vehicle in a same manner in which an article is placed on the support platform; and
(c) configured to obtain information on an amount of operation of the support portion and the vertically moving portion when an article is transferred to or from the adjusting-purpose support surface to adjust the transporting-purpose profile information, and

wherein the adjusting-purpose support surface is capable of being moved such that a height thereof can be varied continuously between an upper limit height and a lower limit height specified in advance.

Because the adjusting-purpose support platform is arranged such that the height of the adjusting-purpose support surface can be adjusted continuously, the height of the adjusting-purpose support surface can be set flexibly. For example, if the height of the adjusting-purpose support surface is fixed structurally, it is not easy to change the height of the adjusting-purpose support surface depending on the specification (for example, distance between the floor surface and the ceiling surface, etc.) of an article transport facility. Even if the structure is such that the adjusting-purpose support surface can be set at a number of discrete levels or heights, there may not be a proper level that matches a required height of the adjusting-purpose support surface. With the arrangement described above, the transporting-purpose profile information can be adjusted by making use of an adjusting-purpose support surface that is capable of being moved such that its height can be adjusted continuously. Therefore, the profile information used as a reference can be shared so that the amount of calculations required for adjusting the profile information can also be reduced. When the article transport facility has many article transport vehicles, the total amount of time required to make the adjustments can also be reduced so that the operational efficiency of the article transport facility can also be improved. Thus, the arrangement described above can provide a technology that can be used to more flexibly position an adjusting-purpose support surface and to adjust an article transport vehicle efficiently.

In one embodiment, the adjusting-purpose support platform preferably includes one or more guide rails provided to extend along a vertical direction, a support portion which is supported at least at one end thereof along a horizontal direction by the one or more guide rails and which has the adjusting-purpose support surface formed in a top surface of the support portion, a vertical movement actuator configured to vertically move the support portion along the one or more guide rails, a position detecting sensor configured to detect a position of the support portion along the vertical direction, and an adjusting platform controller configured to control the vertical movement actuator based on a detection result obtained by the position detecting sensor to place the adjusting-purpose support surface at one or more adjusting-purpose heights specified in advance.

With the arrangement described above, the support portion can be vertically moved continuously (i.e., its height can be varied continuously) by controlling the vertical movement actuator. And because the adjusting-purpose support surface is formed in the top surface of the support portion, the adjusting-purpose support surface can be moved such that its height can be varied continuously.

Here, each of the one or more adjusting-purpose heights is preferably specified based on at least one of: a height of an article support surface of a corresponding support platform configured to place an article thereon; and an amount of operation of the vertically moving portion when the support member is moved from a set raised position specified in advance to a set lowered position for placing an article on the corresponding support platform.

The information (included in the transporting-purpose profile information) on an amount of operation of the support portion and the vertically moving portion for transferring an article depends on the distance between the top surface of a support platform and the set raised position. The distance between the floor surface and the top surface of a support platform is almost constant irrespective of the location at which an article transport facility is installed since the floor surface serves as a reference height, However, the article transport vehicle is suspended from, and supported by, the one or more travel rails supported by the ceiling. And the brackets, etc., for installing or suspending the one or more travel rails from the ceiling are generally of standard dimensions specified by the industry standards; thus, the distance between the top surface of a support platform and the set raised position may vary depending on the location at which the article transport facility is installed. In addition, the amount of operation of the support member and the vertically moving portion may be specified in terms of, among other possibilities, a fed-out amount of a belt, etc., which is used to suspend the support member with respect to the travel portion, or the number of rotations of a pulley which is rotated when feeding out the belt. And such fed-out amount and number of rotations may vary depending on the specification of each ceiling transport vehicle 1 even if the distance of movement (amount of operation) of the support member 24 is the same. Furthermore, a plurality of kinds of article transport vehicles may be used in one article transport facility.

It is preferable that the adjusting-purpose support surface can be placed or positioned such that the transporting-purpose profile information can be adjusted properly even if the distance between the top surface (article support surface) of the support platform and the set raised position described above and the amount of operation of the support member and the vertically moving portion (e.g., fed-out amount or the number of rotations) vary. Therefore, it is preferable that each adjusting-purpose height which specifies the height of an adjusting-purpose support surface is specified based on at least one of a height of the article support surface and the amount of operation of the vertically moving portion when the support member is moved from the set raised position to the set lowered position.

In addition, the plurality of support platforms preferably include a plurality of different kinds of support platforms having article support surfaces of different heights, wherein the one or more adjusting-purpose heights are preferably specified to correspond to the heights of the article support surfaces.

The plurality of support platforms are not necessarily of the same height in one article transport facility. A plurality of different kinds of support platforms having different heights from the floor surface may be used. Because the article transport vehicle transports an article to and from such a plurality of different kinds of support platforms, it is preferable that the adjusting-purpose support surface can be positioned such that the transporting-purpose profile information can be adjusted properly depending on the height of each article support surface of the plurality of kinds of support platforms.

In one embodiment, the adjusting-purpose support platform is provided to a maintenance-purpose vertically moving device configured to remove the article transport vehicle suspended and supported by one or more travel rails to a floor side.

The article transport vehicle which is suspended from, and supported by, the one or more travel rails supported by the ceiling is often lowered to the ground side when performing maintenance work such as an inspection and a repair, in consideration of work efficiency and safety. For this reason, a maintenance-purpose vertically moving device is often provided in the article transport facility for lowering the article transport vehicle to the ground side, i.e., for removing the article transport vehicle from the one or more travel rails supported by the ceiling to the floor side. If an adjusting-purpose support platform is provided separately from such a maintenance-purpose vertically moving device at a position different from where the maintenance-purpose vertically moving device is located, then this may reduce the usable area in the article transport facility. The space necessary for the purpose of maintenance work can be reduced if the adjusting-purpose support platform is provided to the maintenance-purpose vertically moving device. In addition, the amount of time in which the ceiling transport vehicle is away for maintenance and adjustment, etc., can be reduced because the transporting-purpose profile information can be adjusted when performing an inspection and/or repair so that any reduction in the operational efficiency of the ceiling transport vehicle can also be reduced.

What is claimed is:

1. An article transport facility comprising:
one or more travel rails supported by a ceiling;
a plurality of support platforms provided on a ground side and along the one or more travel rails;
an article transport vehicle which is suspended from and supported by the one or more travel rails, and is configured to travel along a travel path defined by the one or more travel rails, to suspend and support an article, and to transport the article from one of the plurality of support platforms that serves as a transport origin to another of the plurality of support platforms that serves as a transport destination, wherein the ceiling transport vehicle has a travel portion configured to travel along the travel path, a support member which is supported by the travel portion and which is configured to hold, suspend, and support, the article, a vertically moving portion configured to vertically move the support member with respect to the travel portion when the travel portion is at rest, and a profile storage configured to store transporting-purpose profile information which includes at least information on an amount of operation of the support portion and the vertically moving portion for transferring an article to or from each of the plurality of support platforms;
an adjusting-purpose device which is used for a purpose of adjusting the transporting-purpose profile information;
an adjusting-purpose support platform which includes an adjusting-purpose support surface on which the adjusting-purpose device can be placed in a same manner in which an article is placed on a support platform;
wherein the adjusting-purpose device is:
capable of being suspended from and supported by the support member in a same manner in which an article is suspended from and supported by the support member;
capable of being placed on a support platform by the article transport vehicle in a same manner in which an article is placed on the support platform; and
configured to obtain information on an amount of operation of the support portion and the vertically moving portion when an article is transferred to or from the adjusting-purpose support surface to adjust the transporting-purpose profile information, and
wherein the adjusting-purpose support surface is capable of being moved such that a height thereof can be varied continuously between an upper limit height and a lower limit height specified in advance.

2. The article transport facility as defined in claim 1, wherein the adjusting-purpose support platform includes one or more guide rails provided to extend along a vertical direction, a support portion which is supported at least at one end thereof along a horizontal direction by the one or more guide rails and which has the adjusting-purpose support surface formed in a top surface of the support portion, a vertical movement actuator configured to vertically move the support portion along the one or more guide rails, a position detecting sensor configured to detect a position of the support portion along the vertical direction, and an adjusting platform controller configured to control the vertical movement actuator based on a detection result obtained by the position detecting sensor to place the adjusting-purpose support surface at one or more adjusting-purpose heights specified in advance.

3. The article transport facility as defined in claim 2, wherein each of the one or more adjusting-purpose heights is specified based on at least one of: a height of an article support surface of a corresponding support platform configured to place an article thereon; and wherein an amount of operation of the vertically moving portion when the support member is moved from a set raised position specified in advance to a set lowered position for placing an article on the corresponding support platform.

4. The article transport facility as defined in claim 3, wherein the plurality of support platforms include a plurality of different kinds of support platforms having article support surfaces of different heights, and
wherein the one or more adjusting-purpose heights are specified to correspond to the heights of the article support surfaces.

5. The article transport facility as defined in claim 1, wherein the adjusting-purpose support platform is provided to a maintenance-purpose vertically moving device configured to remove the article transport vehicle suspended and supported by one or more travel rails to a floor side.

6. The article transport facility as defined in claim 2, wherein the adjusting-purpose support platform is provided to a maintenance-purpose vertically moving device configured to remove the article transport vehicle suspended and supported by one or more travel rails to a floor side.

7. The article transport facility as defined in claim 3, wherein the adjusting-purpose support platform is provided to a maintenance-purpose vertically moving device configured to remove the article transport vehicle suspended and supported by one or more travel rails to a floor side.

8. The article transport facility as defined in claim 4, wherein the adjusting-purpose support platform is provided to a maintenance-purpose vertically moving device configured to remove the article transport vehicle suspended and supported by one or more travel rails to a floor side.
